(19) United States
(12) Patent Application Publication
(10) Pub. No.: US 2013/0016776 A1
(43) Pub. Date: Jan. 17, 2013

(54) Scalable Video Coding Using Multiple Coding Technologies

(71) Applicants: Jill Boyce, Manalapan, NJ (US); Danny Hong, New York, NY (US); Ofer Shapiro, Fair Lawn, NJ (US); Stephan Wenger, Hillsborough, CA (US)

(72) Inventors: Jill Boyce, Manalapan, NJ (US); Danny Hong, New York, NY (US); Ofer Shapiro, Fair Lawn, NJ (US); Stephan Wenger, Hillsborough, CA (US)

(73) Assignee: Vidyo Inc.

(21) Appl. No.: 13/528,010

(22) Filed: Jun. 20, 2012

Related U.S. Application Data
(60) Provisional application No. 61/506,822, filed on Jul. 12, 2011.

(51) Int. Cl. H04N 7/32

(52) U.S. Cl. 375/240.06; 375/240.02; 375/E07.243

(57) ABSTRACT

Techniques for video decoding include decoding a base layer of a first video coding technology and at least one enhancement layer conforming to a second video coding technology. The video coding technologies can be identified in a Dependency Parameter Set. Techniques for video encoding include encoding a base layer in a first video coding technology, at least one enhancement layer in a second video coding technology. Also disclosed are video communication systems using base and enhancement layer.

### CROSS REFERENCE TO RELATED APPLICATIONS

This application claims priority to U.S. Ser. No. 61/506,822 titled “Scalable Video Coding Using Multiple Coding Technologies” filed Jul. 12, 2011, the disclosure of which is hereby incorporated by reference in its entirety.

### FIELD

The disclosed subject matter relates to video coding techniques that allow the use of sub-bitstreams compliant with a plurality of video compression standards in different layers of a scalable bitstream.

### BACKGROUND

Video compression using scalable techniques in the sense used herein allows a digital video signal to be represented in the form of multiple layers. Scalable video coding techniques have been proposed and/or standardized for many years.

ITU-T Rec. H.262, entitled “Information technology—Generic coding of moving pictures and associated audio information: Video”, version 0212000, (available from International Telecommunication Union (ITU), Place des Nations, 1211 Geneva 20, Switzerland, and incorporated herein by reference in its entirety), also known as MPEG-2, for example, includes in some aspects a scalable coding technique that allows the coding of one base and one or more enhancement layers, allowing certain scalability.

ITU Rec. H.263 version 2 (1998) and later (available from International Telecommunication Union (ITU), Place des Nations, 1211 Geneva 20, Switzerland, and incorporated herein by reference in its entirety) also includes scalability mechanisms in its Annex O, allowing certain scalability.

ITU-T Rec. H.264 version 2 (2005) and later (available from International Telecommunication Union (ITU), Place des Nations, 1211 Geneva 20, Switzerland, and incorporated herein by reference in its entirety), and their respective ISO-IEC counterpart ISO/IEC 14496 Part 10 includes scalability mechanisms known as Scalable Video Coding or SVC, in its Annex G.

The specification of spatial scalability in all three aforementioned standards naturally differs in part due to different terminology and/or different coding tools of the non-scalable specification basis, and different tools used for implementing scalability. However, an exemplary implementation strategy for a scalable encoder configured to encode a base layer and one enhancement layer is to include two encoding loops; one for the base layer, the other for the enhancement layer. Additional enhancement layers can be added by adding more coding loops. This has been discussed, for example, in Dugad, R, and Ahuja, N, “A Scheme for Spatial Scalability Using Nonscalable Encoders”, IEEE CSVT, Vol 13 No. 10, October 2003, which is incorporated by reference herein in its entirety.

These standards allow for spatial and SNR scalability. There have been attempts to “mix” video coding standards by stepping outside of compliance of the standards themselves. For example, a protocol with multiplex functionality such as RTP (Schulzrinne, H., Casner, S., Frederick, R., and V. Jacobson, “RTP: A Transport Protocol for Real-Time Applications”, STD 64, RFC 3550, July 2003, available from http://www.rfc-editor.org/rfc/pdfrfc/rfc3984.txt.pdf) or MPEG-2 systems (ITU-T Rec. H.222.0 (“Information technology—Generic coding of moving pictures and associated audio information: Systems”, May 2006, available from International Telecommunication Union (ITU), Place des Nations, 1211 Geneva 20, Switzerland, and incorporated herein by reference in its entirety) allow multiplexing of bitstream stemming from different coders compliant with different coding technologies or coding standards.

However, such protocols do not permit describing the semantic relationship (in terms of layering) between multiple video sub-bitstreams conveyed, for example, in multiple RTP sessions or as multiple MPEG-2 Systems Elementary Streams. In the case of RTP, for example, the semantic relationship of RTP sessions as layers is specified in T, Schierl and S. Wenger, “Signaling Media Decoding Dependency in the Session Description Protocol (SDP)” RFC 5583, July 2009, available from http://www.rfc-editor.org/rfc/rfc5583.txt and incorporated herein in its entirety. In its section 5.1, the aforementioned RFC5583 specifically limits its applicability to describe the relationship of, for example, RTP sessions, of the same media type. A media type, in this context, corresponds to a video coding standard being used for encoding, for example, a layer that is transported in an RTP session.

Further, the use of side information of reference pictures (as common in modern video coding standards) for inter layer prediction utilizes a standardized upscale unit in such protocols to avoid drift.

It can be desirable to allow different layers of a scalable bitstream to be compliant with different video coding standards. One exemplary scenario can involve legacy video coding standards for the base layer and modem video coding standards for enhancement layer(s). For example, certain video conferencing endpoints support H.264, but do not support a currently under development video coding standard known as HEVC (for the current status of the HEVC specification it is referred to “Bross et. al., High efficiency video coding (HEVC) text specification draft 6, JCTVC-H1003_dK, February 2012” (henceforth referred to as “WD6” or “HEVC”), which is incorporated herein by reference in its entirety. A scalable bitstream including an H.264 compliant base layer and an HEVC compliant enhancement layer can be decoded at a legacy endpoint, albeit at a lower quality level as only the base layer is being decoded, and at a state-of-the-art endpoint that can decode both base and enhancement layer, thereby improved quality.

Referring to FIG. 1, shown is a block diagram of an exemplary prior art scalable encoder, such as described in Dugad, R, and Ahuja, N, “A Scheme for Spatial Scalability Using Nonscalable Encoders”, IEEE CSVT, Vol 13 No. 10, October 2003, which is incorporated by reference herein in its entirety. MPEG-2 non-scalable coding can be used for both base and enhancement layer coding loops.

A scalable encoder can include a video signal input (101), a downsample unit (102), a base layer coding loop (103), a base layer reference picture buffer (104) that can be part of the base layer coding loop but can also serve as an input to a reference picture upsample unit (105), an enhancement layer coding loop (106), and a bitstream generator (107).

The video signal input (101) can receive the to-be-coded video in any suitable digital format, for example according to ITU-R Rec. BT.601 (March 1982) (available from International Telecommunication Union (ITU), Place des Nations, 1211 Geneva 20, Switzerland, and included herein by reference in its entirety). The term “receive” can involve pre-processing steps such as filtering, resampling to, for example, the intended enhancement layer spatial resolution, and other operations. The spatial picture size of the input signal can be the same as the spatial picture size of the enhancement layer. The input signal can be used in unmodified form (108) in the enhancement layer coding loop (106), which is coupled to the video signal input.

Coupled to the video signal input can also be a downsample unit (102). A purpose of the downsample unit (102) can be to down-sample the pictures received by the video signal input (101) in enhancement layer resolution, to a base layer resolution. Video coding standards as well as application constraints can set constraints for the base layer resolution. The scalable baseline profile of F1.264/SVC, for example, allows downsample ratios of 1.5 or 2.0 in both X and Y dimensions. A downsample ratio of 2.0 means that the downsampled picture includes only one quarter of the samples of the non-downsampled picture. In certain video coding standards, the details of the downsampling mechanism can be chosen freely, independently of the upsampling mechanism. In contrast, the filter used for up-sampling is typically specified, so to avoid drift in the enhancement layer coding loop (105).

The output of the downsampling unit (102) can be a downsampled version of the picture as produced by the video signal input (109).

The base layer coding loop (103) takes the downsampled picture produced by the downsample unit (102), and encodes it into a base layer bitstream(110).

Many video compression technologies rely, among others, on inter picture prediction techniques to achieve high compression efficiency. Inter picture prediction allows for the use of information related to one or more previously decoded (or otherwise processed) picture(s), known as a reference picture, in the decoding of the current picture. Examples for inter picture prediction mechanisms include motion compensation, where during reconstruction blocks of pixels from a previously decoded picture are copied or otherwise employed after being moved according to a motion vector, or residual coding, where, instead of decoding pixel values, the potentially quantized difference between a (including in some cases motion compensated) pixel of a reference picture and the reconstructed pixel value is contained in the bitstream and used for reconstruction. Inter picture prediction is one technology that can enable good coding efficiency in modern video coding.

Conversely, an encoder can also create reference picture(s) in its coding loop.

While in non-scalable coding, the use of reference pictures is of particular relevance in inter picture prediction, in case of scalable coding, reference pictures can also be relevant for cross-layer prediction. Cross-layer prediction can involve the use of a base layer's reconstructed picture, as well as other base layer reference picture(s) as a reference picture in the prediction of an enhancement layer picture. This reconstructed picture or reference picture can be the same as the reference picture(s) used for inter picture prediction. However, the generation of such a base layer reference picture can be required even if the base layer is coded in a manner, such as intra picture only coding, that would, without the use of scalable coding, not require a reference picture.

While base layer reference pictures can be used in the enhancement layer coding loop, shown here for simplicity is only the use of the reconstructed picture (the most recent reference picture) (111) for use by the enhancement layer coding loop. The base layer coding loop (103) can generate reference picture(s) in the aforementioned sense, and store it in the reference picture buffer (104).

The picture(s) stored in the reconstructed picture buffer (111) can be upsampled by the upsample unit (105) into the resolution used by the enhancement layer coding loop (106). The enhancement layer coding loop (106) can use the upsampled base layer reference picture as produced by the upsample unit (105) in conjunction with the input picture coming from the video input (101), and reference pictures (112) created as part of the enhancement layer coding loop in its coding process. The nature of these uses depends on the video coding standard, and has already been briefly introduced for some video compression standards above. The enhancement layer coding loop (106) can create an enhancement layer bitstream (113), which can be processed together with the base layer bitstream (110) and control information (not shown) so to create a scalable bitstream (114).

Against this background, there exists a need for a multistandard scalability technique adapted to support scenarios where, for example, the base layer is decodable by deployed legacy equipment implementing, for example, an older, less efficiency video coding standard, whereas the enhancement layer is coded conforming to a different, for example, newer and more efficient video coding standard.

### SUMMARY

The disclosed subject matter provides techniques for using a plurality of coding technologies that can, for example, be specified in different video coding standards, in a scalable bitstream, and for decoding such bitstreams

In one embodiment there is provided techniques for identifying a video coding technology in at least one layer of a scalable bitstream.

In one embodiment, a video encoder includes, for example in a dependency parameter set, information indicative of the use of a first video coding technology for coding a given layer, and different information indicative of a second video coding technology for coding of another given layer, where both layers are in included the same scalable bitstream.

In the same or another embodiment, a video decoder can read, for example from a dependency parameter set, information indicative of the use of a first video coding technology for coding a given layer, and different information indicative of a second video coding technology for coding of another given layer, where both layers are in coded the same scalable bitstream.

In the same or another embodiment, information related to the use of coding technologies in layers can be communicated during a capability negotiation or announcement.

### BRIEF DESCRIPTION OF THE DRAWINGS

Further features, the nature, and various advantages of the disclosed subject matter will be more apparent from the following detailed description and the accompanying drawings in which:

FIG. 1 shows an exemplary scalable video encoder in accordance with Prior Art;

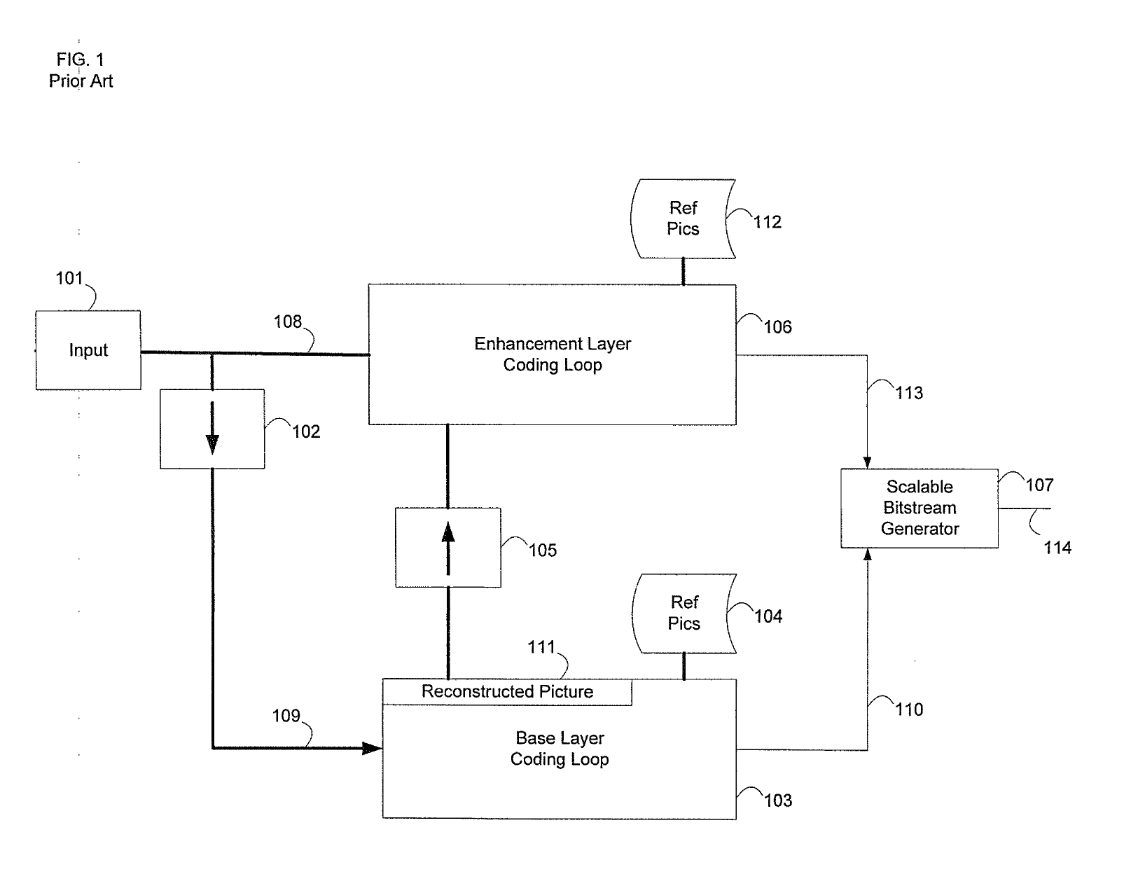

FIG. 2 shows an exemplary encoder in accordance with an embodiment of the present disclosure;

FIG. 3 shows an exemplary encoder in accordance with an embodiment of the present disclosure;

FIG. 4 shows an exemplary system in accordance with an embodiment of the present disclosure;

FIG. 5 shows an exemplary computer system in accordance with an embodiment of the present disclosure.

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

Throughout the description of the disclosed subject matter the term “base layer” refers to the layer in the layer hierarchy on which the enhancement layer is based on using inter-layer prediction. In environments with more than two enhancement layers, the base layer, as used in this description, does not need to be the lowest possible layer.

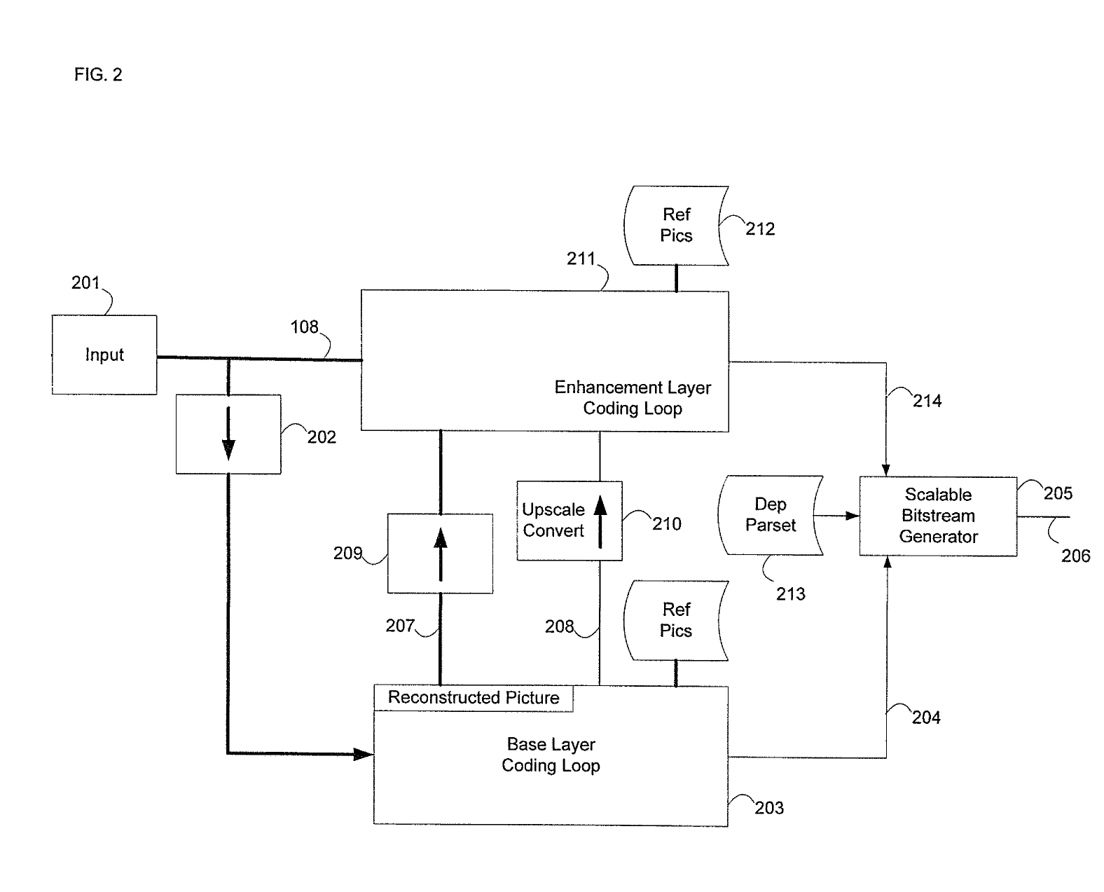

FIG. 2 shows a block diagram of an exemplary two layer encoder in accordance with one aspect of the disclosed subject matter. The encoder can be extended to support more than two layers by adding additional enhancement layer coding loops. One consideration in the design of this encoder has been to keep the changes to the coding loops, compared to a non-scalable encoder's coding loop, as small as feasible. Another is to increase the independence of the coding loops from each other, in the sense that they can use different video coding technologies; for example, they can be based on different video compression standards.

The encoder can receive uncompressed input video (201), which can be downsampled in a downsample module (202) to base layer spatial resolution, and can serve in downsampled form as input to the base layer coding loop (203). In an embodiment, the base layer coding loop (203) operates using a coding technology different from the coding technology used in the enhancement layer coding loop (211). Different coding technology can refer to a different syntax and/or semantics associated with the syntax elements contained in the bitstream representing a layer and encoded/decoded by the respective coding loops. The underlying principle of operation of both coding loops can be the same, and can, for example, be based on inter picture prediction with motion compensation and transform coding of the residual signal. Different coding technologies in this sense can refer to the use of syntax and semantics specified in different standards; for example the base layer can be coded in compliance with H.264 (or MPEG-2), whereas the enhancement layer can be coded using a scalable extension of HEVC. Described below is such an example: H.264 as a base layer, and a scalable extension of HEVC as the enhancement layer.

The downsample factor used by downsample module (202) can be 1.0, in which case the spatial dimensions of the base layer pictures are the same as the spatial dimensions of the enhancement layer pictures; resulting in a quality scalability, also known as SNR scalability. Downsample factors larger than 1.0 lead to base layer spatial resolutions lower than the enhancement layer resolution. A video coding standard can put constraints on the allowable range for the downsampling factor. The factor can also be dependent on the application.

The base layer coding loop (203) can generate the following output signals used in other modules of the encoder:

A) Base layer coded bitstream bits (204) which can form their own, possibly self-contained, base layer bitstream, which can be made available for examples to decoders compliant with the coding technology used in the base layer encoder such as H.264 (not shown), or can be combined with enhancement layer bits (which can be compliant with a coding technology different from the coding technology used in the base layer such as HEVC) and control information in a scalable bitstream generator (205), which can, in turn, generate a scalable bitstream (206). In the same or another embodiment, the base layer bitstream can be in a first bitstream format, which can, for example, be compliant with H.264. In the same or another embodiment, the control information can include a dependency parameter set (214), described later in more detail, which can include information specifying the layering structure of the scalable bitstream as well as the compression technologies used in the base layer and/or enhancement layer coding loop.

B) Reconstructed picture (or parts thereof) (207) of the base layer coding loop (base layer picture henceforth), in the pixel domain, of the base layer coding loop that can be used for cross-layer prediction. The base layer picture can be at base layer resolution, which, in case of SNR scalability, can be the same as enhancement layer resolution. In case of spatial scalability, base layer resolution can be different, for example lower, than enhancement layer resolution.

C) Reference picture side information (208). This side information can include, for example information related to the motion vectors that are associated with the coding of the reference pictures, macroblock or Coding Unit (CU) coding modes, intra prediction modes, and so forth. The nature of the reference picture side information can be dependent on the video coding technology/standard used in the base layer coding loop (203). The “current” reference picture (which is the reconstructed current picture or parts thereof) can have more such side information associated with than older reference pictures.

Base layer picture and side information can be processed by an upsample unit (209) and an upscale units (210), respectively, which can, in case of the base layer picture and spatial scalability, upsample the samples to the spatial resolution of the enhancement layer using, for example, an interpolation filter that can be specified in one of the video compression standards involved; see below.

The operation of the upsample unit (209) can be relatively straightforward when the coding technology for the base layer and the coding technology for the enhancement layer share substantially similar technologies for using multiple reference pictures. However, when reference picture functionalities are different, and the enhancement layer coding technology requires access to multiple reference pictures in the base layer which are not supported by the base layer coding technology, the operation of the upsample unit (209) can involve additional operations such as caching previously upsampled picture(s) or parts thereof, maintaining its own reference picture lists (for example as specified in H.264 or HEVC or comparable technology), and so forth.

In case of reference picture side information, equivalent, for example scaling, transforms can be used. For example, motion vectors can be scaled by multiplying, in both X and Y dimension, the vector generated in the base layer coding loop (203).

The upscale unit (210) can also include converters that convert information produced by the base layer encoding using a first video coding technology to a format used in the enhancement layer coding loop, which can use a different video coding technology. Such conversion can, for example, include rounding, interpolation, and insertion or removal of information. For example, if the base layer coding loop would operate with motion vector granularities at ⅓^{rd} pixel accuracy (as, for example, early proposals to H.264 did), and the enhancement layer would operate with motion vector granularities of ¼ pixels (as, for example, 1.264 or HEVC do), then the upscale unit (210) can be responsible to covert such motion vectors. Similarly, the upscale unit can be changing other information of the base layer such as intra prediction modes to the “nearest” appropriate mode used by the enhancement layer's coding technology.

The motion vectors in the base layer coding loop represent motion between the current picture and the reference picture. The temporal distance between the current picture and the reference picture may vary. The motion vectors used for prediction can be scaled by the relative temporal distances when the prediction motion vector spans a different temporal distance than the current block being coded. For example, if the motion vector predictor referred to a picture one frame distance away, but the current predictor referred to a picture two frame distances away, the prediction motion vector would be doubled before it was used as a predictor. The temporal distance of the base coding layer, in coding order, can be determined so that the enhancement layer coding layer can scale the prediction motion vector. In H.264, a reference index syntax element indicates which reference picture is used from a list of candidate reference pictures, and a picture order count (POC) syntax element represents the temporal position of the coded pictures. An H.264 base coding layer may contain a different reference picture list than the HEVC enhancement coding layer, so a mapping to the actual temporal position can be needed in order to determine the temporal distance.

In some cases, no appropriate conversion of side information may be possible, for example because the enhancement layer's coding technology lacks a coding tool of the base layer. In such a case, the upscale unit may elect not to attempt to convert these aspects of the side information. This can be relevant, for example, when the base layer is coding in interlace mode (for example using MPEG-2), whereas the enhancement layer is coded in a technology that does not allow interlace coding, and similar cases.

As a mismatch in technologies used in the upsample unit (209) and/or upscale unit (210) used in encoder and decoder (to be described later) can lead to drift, the operation of the upsample unit (209) and/or upscale unit (210) can advantageously be specified in a video compression standard, which can, for example, be the standard specifying the base layer decoding, the standard specifying the enhancement layer decoding, or a third standard specifying the use of more than one video compression standard in layered coding.

In the same or another embodiment, an enhancement layer coding loop (211) can operate using a different coding technology than the base layer's coding loop's (203) coding technology. It can contain its own reference picture buffer(s) (212), which can contain reference picture sample data generated by reconstructing coded enhancement layer pictures previously generated, as well as associated side information.

In the same or another embodiment, the encoder can further include a Dependency Parameter Set generator (213), which can generate and store one or more dependency parameter sets, Dependency parameter sets have been described, for example, in U.S. patent application Ser. No. 13/414,075, entitled “DEPENDENCY PARAMETER SET FOR SCALABLE VIDEO CODING”, which is incorporated herein by reference in its entirety. The purpose of a dependency parameter set can include to tie together various layers of a scalable bitstream in the sense of identifying the use-relationship between those layer. The dependency parameter set can be part of a scalable bitstream.

In the same or another embodiment, the dependency parameter set can contain, for at least one layer, information pertaining to the video compression technology used in this layer. For example, the dependency parameter set can contain a single bit for one or more layers that signals the use of H.264 or HEVC for this layer. Alternatively, more complex information can be used to signal the use of more than two alternatives for coding technologies. The information can be in any suitable format, for example: in binary format, coded in accordance with the entropy coding engine of the standard to which the base or enhancement layer is compliant to, SDP, or XML.

The dependency parameter set, or substantially similar information in a different format, can also be used in capability negotiation and/or announcement mechanisms as described later.

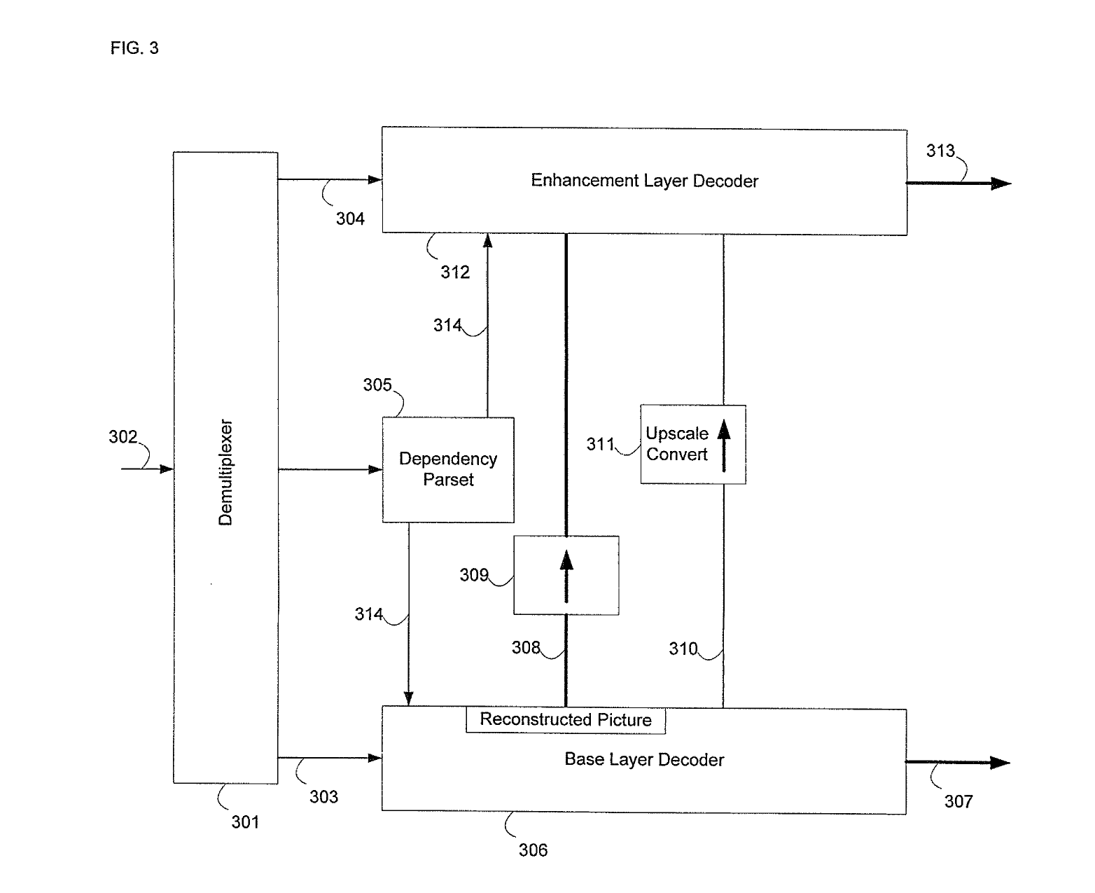

FIG. 3 shows a decoder according to an embodiment of the disclosed subject matter. A demultiplexer (301) can split a received scalable bitstream (302) into, for example, a base layer bitstream (303) and an enhancement layer bitstream (304). Further, the demultiplexer can recreate, from the scalable bitstream or out-of-band information, a dependency parameter set (305) that can contain the same information as the dependency parameter set generated by the encoder. It can therefore contain information pertaining to the layering structure of the scalable bitstream and, according to the same or another embodiment, can also include, for at least one layer, an indication of the coding mechanism used to decode the bitstream of the layer in question. This information can, for example, refer to a video coding standard or any other suitable information that describes the operation of a decoder.

A base layer decoder (306) can create a reconstructed picture sequence that can be output (307) if so desired by the system design. Parts or all of the reconstructed picture sequence (308) can also be used by cross-layer prediction after being upsampled in an upsample unit (309). Similarly, side information (310) can be created during the decoding process and can be upscaled by an upscale unit (311). Upscale unit and upsample unit have already been described in the context of the encoder, and should operate such that, for a given input, the output is substantially similar to the output of the encoder's upsample/upscale units so to avoid drift between encoder and decoder. This can be achieved by standardizing the upsample/upscale mechanisms, and requiring conformance of the upsample/upscale units of both encoder and decoder with the standard.

The enhancement layer decoder (312) can create enhancement layer pictures (313) that can be output for use by the application.

According to the same or another embodiment, base layer decoder and enhancement layer decoder can operate according to different video decoding technologies, identified (314) by aforementioned information that can be part of the dependency parameter set.

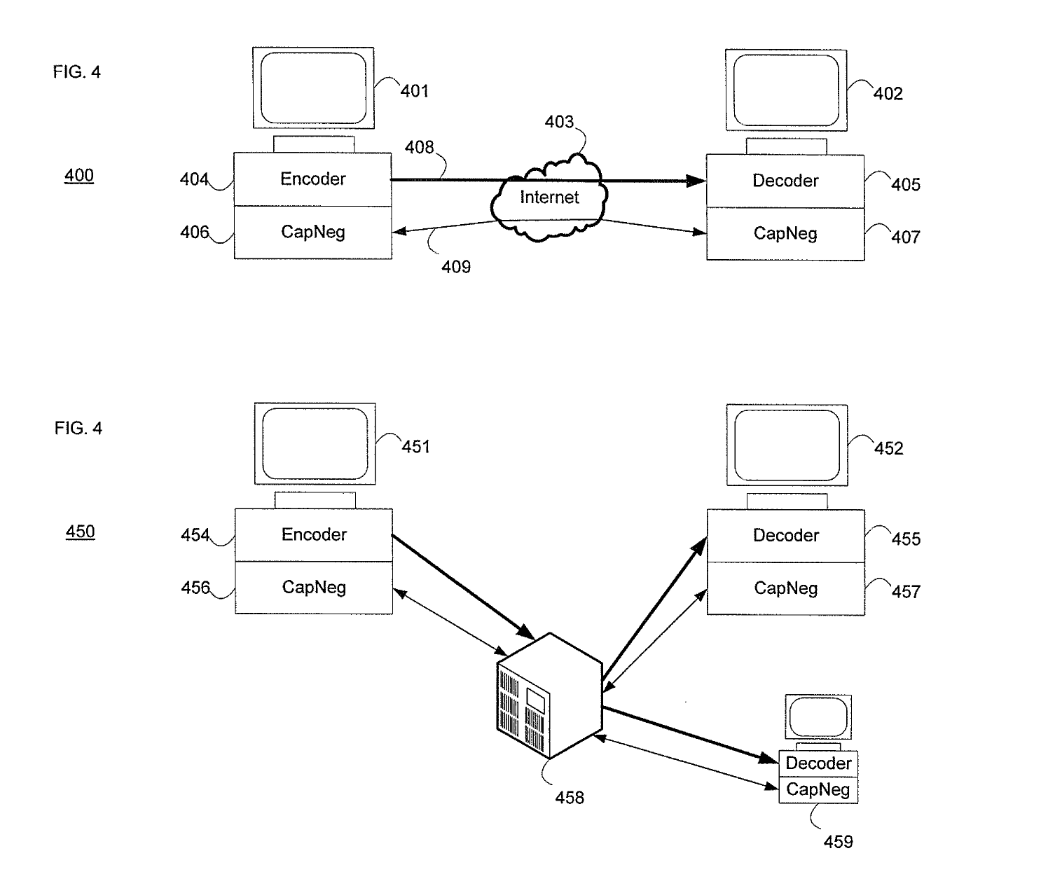

FIG. 4 shows two exemplary system configurations (400) (450) in which the disclosed subject matter can be used. System (400) includes two endpoints (401) (402) that are connected through network (403). Endpoint (401) is described here as a video sender, and endpoint (402) is described here as a video receiver; however, a person skilled in the art will readily understand that, using similar technologies, bi-directional communication is also possible.

Sending endpoint (401) can include a scalable encoder (404) substantially similar to the one already described. It also can include a capability negotiation module (405). Receiving endpoint (402) can include a scalable video decoder (406) and a capability negotiation module (407). The scalable encoder (404) and decoder (406) can communicate unidirectionally over the media path (408) using a physical or virtual connection or any other form of transmission (such as a datagram service) using, for example network (403). The capability negotiation modules (405) (407) also communicate over a signaling path (409) with each other, but in their case, the communication relationship can be bi-directional. Signaling path and media path are shown to be conveyed over the same network (403) (for example the Internet), but could also be conveyed over different networks.

Dependency parameter sets as described above, can be conveyed over either or both signaling path or media path.

The option of using more than one coding technology in a given scalable bitstream adds another dimension to the capability exchange process known to those skilled in the art. Specifically, under this option, it would not be sufficient that sending endpoint (401) and receiving endpoint (402) agree on one of a set of possible coding technologies; rather they should agree on a combination of different coding technologies. For example, if the base layer can be H.264 or HEVC, and the enhancement layer can also be H.264 or HEVC, there may be four different combinations of coding technologies. But not all possible combinations of coding technologies need to be implemented on both sender and receiver. For example, a sender may only be implementing H.264 for the base layer as the computationally lightweight coding standard. There can be a need to select the operation point of the scalable bitstream sent between encoder and decoder so that the two can understand each other, even if they do not implement all permutations of possible coding technologies.

Many different mechanisms to establish such an understanding have been proposed in various forums. Briefly described is the mechanism defined in RFC 5583 and references therein, in the context of the SIP offer-answer model. According to the RFC, a future media sender (such as endpoint 401) can “offer” the structure of layers it can support, (indirectly, in the media description) including information such as the parameters of the codec in question, such as profile and level. The future media receiver (such as receiving endpoint 402) can pick one of the structure of layers “offered” by the future sender, and return it to the future sender as an “answer”, possibly including downgrading of abilities.

According to an embodiment, the information sent in “offer” and “answer” can further include an indication of a media type that can be different between each layer, thereby allowing different media coding technologies in each layer. In the same or another embodiment, the future media sender can signal all, or a subset of, the possible permutation of layering and coding technologies. The subset can, for example, be dependent on known network conditions, known CPU load constraints, and similar factors that would disallow the use of certain coding technologies but allow for others. In the same or another embodiment, the future media receiver can select between the offers made by the sender, using similar criteria, so to optimize the reproduced picture quality once media communication commences.

In the same or another embodiment, similar arrangements can occur during the lifetime of a media transmission so to adjust the layering structure and/or the coding technologies used for each layer to, for example, the current network conditions, user interface settings (receiving display window sizes) and other factors.

Returning to FIG. 4, in an embodiment, system 450 contains sending (451) and receiving endpoint (452), network (453), scalable video encoder (404) and decoder (406), and capability negotiation modules in sender and receiver (455, 457), which operate similar as already discussed unless indicated otherwise. However, further included in system (450) is a Central Video Conferencing Switch (CVCS) (458) and a third endpoint (459) as an example for a multipoint conference. Aspects of the CVCS have been described, for example, in U.S. Pat. No. 7,593,032 entitled “SYSTEM AND METHOD FOR A CONFERENCE SERVER ARCHITECTURE FOR LOW DELAY AND DISTRIBUTED CONFERENCING APPLICATIONS” which is incorporated herein by reference in its entirety. The CVCS can be involved in both signaling and media path as described now.

During signaling (which can occur before media sending commences or during the media session in order to re-negotiate an operation point), the capability negotiation module (455) in the sending endpoint (451) can announce its capabilities to the CVCS. This “offer” to the CVCS can be similar to the offer in the “offer-answer” model described above. However, the offer can also include information about different layering structures that can be sent simultaneously. For example, it is possible that an endpoint can signal that it supports, simultaneously, the sending of an H.264 base layer and an HEVC enhancement layer, as well as an HEVC base and enhancement layer.

The CVCS can reply to the “offer” with one or more options it can receive. Accordingly, the scalable video encoder in the endpoint can commence sending one or more scalable representation of the video signal, each of which can include multiple layers that can include multiple coding technologies such as H.264 or HEVC.

Similarly, a receiving endpoint (452) can communicate with the CVCS its capabilities and optionally preferences for reception, by sending an “offer” for formats it can receive, with the CVCS replying its options for formats the endpoint should be prepared to receive.

Once media sending commences, the sending endpoint can send one or more representations simultaneously, each including a scalable bitstream that can include layers according to one or more media coding technologies. The selection can be driven by one or more of, the result of the capability negotiation between sending endpoint and CVCS, the current network conditions as perceived by the sending endpoint, during-session signaling by the CVCS indicating, for example, the need or desirability of sending (or not sending) of a certain representation, and so forth.

The CVCS can receive the media information, and may forward only those layers of those representation that fall within the capabilities as communicated by the receiving endpoint, current network conditions, and during session signaling by the receiving endpoint that can include, for example, factors such as rendering picture size at the receiving endpoint or CPU load.

In a multipoint scenario, that is where the video sent by a sending endpoint 451 is (indirectly, after being relayed by CVCS (458)) received by more than one endpoint (here, shown are receiving endpoints (452) and (459)), the CVCS can, among other things, drop layers or parts thereof, individually for each receiving endpoint, as required for best possible reproduction quality in receiving endpoints (452) and (459) as disclosed in U.S. Pat. No. 7,593,032. However, according to an embodiment, the CVCS can also switch between different representations including different video coding technologies, if this is advantageous in the receiving endpoint. For example, if a receiving endpoint (452) signals the CVCS (458) that it is short of CPU cycles, for example, due to activities other than video conferencing, the CVCS can switch, assuming such formats are available from sending endpoint (451), to a representation coded in a less demanding video coding technology, thereby saving decoding cycles at the receiving endpoint and allowing to keep up a high resolution decoding and/or stay in the video conference altogether.

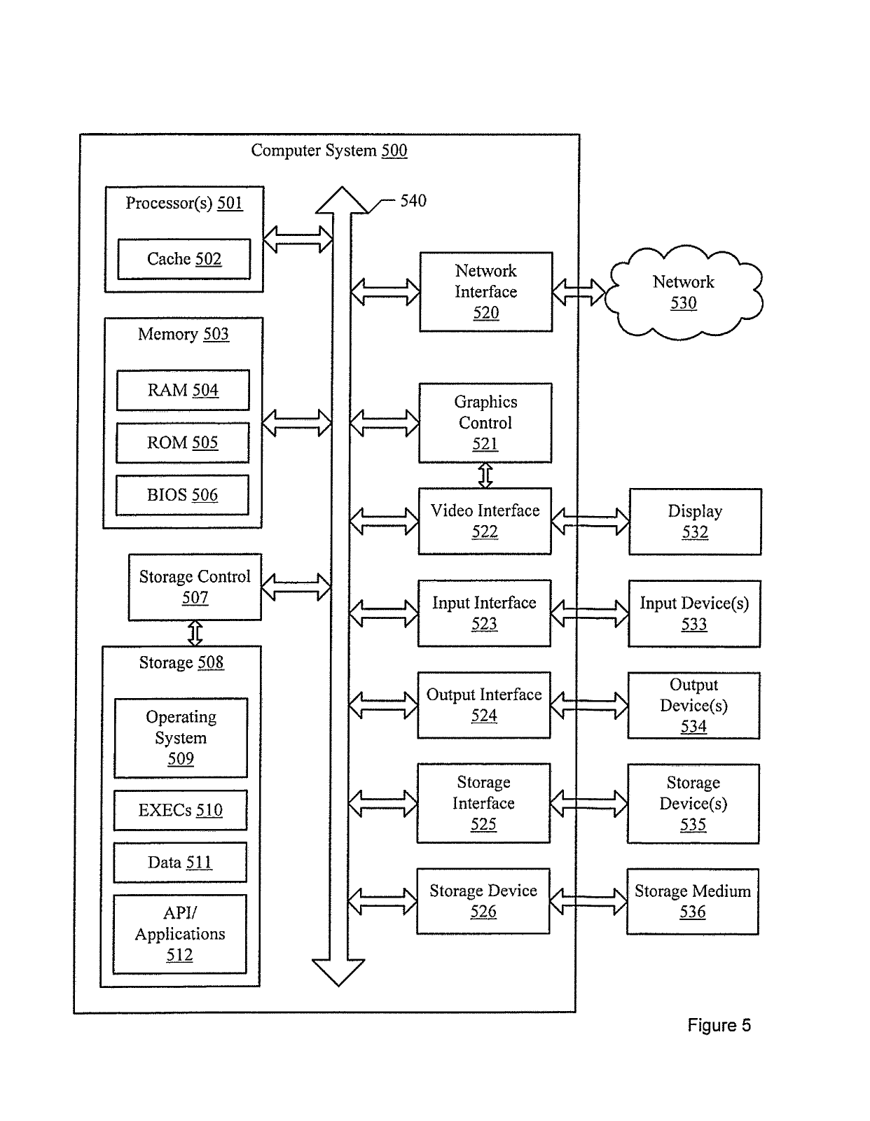

The methods for scalable coding/decoding using difference and pixel mode, described above, can be implemented as computer software using computer-readable instructions and physically stored in computer-readable medium. The computer software can be encoded using any suitable computer languages. The software instructions can be executed on various types of computers. For example, FIG. 5 illustrates a computer system 500 suitable for implementing embodiments of the present disclosure.

The components shown in FIG. 5 for computer system 500 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 500 can have many physical forms including an integrated circuit, a printed circuit board, a small handheld device (such as a mobile telephone or PDA), a personal computer or a super computer.

Computer system 500 includes a display 532, one or more input devices 533 (e.g., keypad, keyboard, mouse, stylus, etc.), one or more output devices 534 (e.g., speaker), one or more storage devices 535, various types of storage medium 536.

The system bus 540 link a wide variety of subsystems. As understood by those skilled in the art, a “bus” refers to a plurality of digital signal lines serving a common function. The system bus 540 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 501 (also referred to as central processing units, or CPUs) optionally contain a cache memory unit 502 for temporary local storage of instructions, data, or computer addresses. Processor(s) 501 are coupled to storage devices including memory 503. Memory 503 includes random access memory (RAM) 504 and read-only memory (ROM) 505. As is well known in the art, ROM 505 acts to transfer data and instructions uni-directionally to the processor(s) 501, and RAM 504 is used typically to transfer data and instructions in a bi-directional manner. Both of these types of memories can include any suitable of the computer-readable media described below.

A fixed storage 508 is also coupled bi-directionally to the processor(s) 501, optionally via a storage control unit 507. It provides additional data storage capacity and can also include any of the computer-readable media described below. Storage 508 can be used to store operating system 509, EXECs 510, application programs 512, data 511 and the like and is typically a secondary storage medium (such as a hard disk) that is slower than primary storage. It should be appreciated that the information retained within storage 508, can, in appropriate cases, be incorporated in standard fashion as virtual memory in memory 503.

Processor(s) 501 is also coupled to a variety of interfaces such as graphics control 521, video interface 522, input interface 523, output interface 524, storage interface 525, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 501 can be coupled to another computer or telecommunications network 530 using network interface 520. With such a network interface 520, it is contemplated that the CPU 501 might receive information from the network 530, or might output information to the network in the course of performing the above-described method. Furthermore, method embodiments of the present disclosure can execute solely upon CPU 501 or can execute over a network 530 such as the Internet in conjunction with a remote CPU 501 that shares a portion of the processing.

According to various embodiments, when in a network environment, i.e., when computer system 500 is connected to network 530, computer system 500 can communicate with other devices that are also connected to network 530. Communications can be sent to and from computer system 500 via network interface 520. For example, incoming communications, such as a request or a response from another device, in the form of one or more packets, can be received from network 530 at network interface 520 and stored in selected sections in memory 503 for processing. Outgoing communications, such as a request or a response to another device, again in the form of one or more packets, can also be stored in selected sections in memory 503 and sent out to network 530 at network interface 520. Processor(s) 501 can access these communication packets stored in memory 503 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 500 can provide functionality as a result of processor(s) 501 executing software embodied in one or more tangible, computer-readable media, such as memory 503. The software implementing various embodiments of the present disclosure can be stored in memory 503 and executed by processor(s) 501. A computer-readable medium can include one or more memory devices, according to particular needs. Memory 503 can read the software from one or more other computer-readable media, such as mass storage device(s) 535 or from one or more other sources via communication interface. The software can cause processor(s) 501 to execute particular processes or particular parts of particular processes described herein, including defining data structures stored in memory 503 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

We claim:

1. A method for decoding video encoded in a base layer and at least one enhancement layer, comprising:
decoding at least one first sample of at least a first picture coded in a base layer encoded in accordance with a first video coding technology; and
decoding at least one second sample of at least a second picture coded in an enhancement layer encoded in accordance with a second video coding technology;
wherein the decoding of the at least one second sample comprises predicting the at least one second sample from the decoded at least one first sample;
wherein the first video coding technology is different from the second video coding technology.

2. The method of claim 1, wherein the first video coding technology comprises encoding which complies with a first video compression standard.

3. The method of claim 1, wherein the second video coding technology comprises encoding which complies with a second video compression standard, said second video compression standard being different than the first video compression standard.

4. The method of claim 2, wherein the first video compression standard comprises H.264.

5. The method of claim 2, wherein the first video compression standard comprises MPEG-2.

6. The method of claim 3, wherein the second video compression standard comprises a scalable extension to HEVC.

7. The method of claim 1, wherein the predicting of the at least one second sample comprises upsampling of the at least one first sample to form a predictor for the at least one second sample.

8. The method of claim 1, wherein the predicting of the at least one second sample comprises creating upscaled side information by the decoding of the at least one first sample.

9. The method of claim 8, wherein the upscaled side information comprises at least one motion vector.

10. The method of claim 1, wherein the first coding technology comprises technology identified in a Dependency Parameter Set.

11. The method of claim 1, wherein the second coding technology comprises technology identified in a Dependency Parameter Set.

12. A method for encoding video in a base layer and at least one enhancement layer, comprising:
encoding at least one first sample of at least a first picture in the base layer in accordance with a first video coding technology; and
encoding at least one second sample of at least a second picture in the enhancement layer in accordance with a second video coding technology;
wherein the encoding of the at least one second sample comprises predicting the at least one second sample from the reconstructed encoded at least one first sample;
wherein the first video coding technology is different from the second video coding technology.

13. The method of claim 12, wherein the first video coding technology comprises encoding which complies with a first video compression standard.

14. The method of claim 12, wherein the second video coding technology comprises encoding which complies with a second video compression standard, said second video compression standard being different than the first video compression standard.

15. The method of claim 13, wherein the first video compression standard comprises H.264.

16. The method of claim 13, wherein the first video compression standard comprises MPEG-2.

17. The method of claim 14, wherein the second video compression standard comprises a scalable extension to HEVC.

18. The method of claim 12, wherein the predicting of the at least one second sample comprises upsampling of the at least one first sample to form a predictor for the at least one second sample.

19. The method of claim 12, wherein the predicting of the at least one second sample comprises creating upscaled side information from the reconstruction of the encoded at least one first sample.

20. The method of claim 19, wherein the upscaled side information comprises at least one motion vector.

21. The method of claim 12, wherein the first coding technology comprises technology identified in a Dependency Parameter Set.

22. The method of claim 12, wherein the second coding technology comprises technology identified in a Dependency Parameter Set.

23. A system for video decoding comprising:
a decoder configured to:
decode at least one first sample of at least a first picture coded in a base layer encoded in accordance with a first video coding technology; and
decode at least one second sample of at least a second picture coded in an enhancement layer encoded in accordance with a second video coding technology,
further configured to: predict the at least one second sample from the decoded at least one first sample,
wherein the first video coding technology is different from the second video coding technology.

24. The system of claim 23, wherein the first video coding technology comprises encoding which complies with a first video compression standard.

25. The system of claim 23, wherein the second video coding technology comprises encoding which complies with a second video compression standard, said second video compression standard being different than the first video compression standard.

26. The system of claim 24, wherein the first video compression standard comprises H.264.

27. The system of claim 25, wherein the first video compression standard comprises MPEG-2.

28. The system of claim 26, wherein the second video compression standard comprises a scalable extension to HEVC.

29. The system of claim 23, wherein the decoder is further configured to: upsample the at least one first sample to form a predictor for the at least one second sample.

30. The system of claim 23, wherein the decoder is further configured to: create upscaled side information by the decoding of the at least one first sample.

31. The system of claim 30, wherein the upscaled side information comprises at least one motion vector.

32. The system of claim 23, wherein the first coding technology comprises technology identified in a Dependency Parameter Set.

33. The system of claim 23, wherein the second coding technology comprises technology identified in a Dependency Parameter Set.

34. A system for video encoding comprising:
an encoder configured to:
encode at least one first sample of at least a first picture in a base layer encoded in accordance with a first video coding technology; and
encode at least one second sample of at least a second picture in an enhancement layer encoded in accordance with a second video coding technology,
further configured to: predict the at least one second sample from the encoded at least one first sample,
wherein the first video coding technology is different from the second video coding technology.

35. The system of claim 34, wherein the first video coding technology comprises encoding which complies with a first video compression standard.

36. The system of claim 34, wherein the second video coding technology comprises encoding which complies with a second video compression standard, said second video compression standard being different than the first video compression standard.

37. The system of claim 35, wherein the first video compression standard comprises H.264.

38. The system of claim 36, wherein the first video compression standard comprises MPEG-2.

39. The system of claim 37, wherein the second video compression standard comprises a scalable extension to HEVC.

40. The system of claim 34, wherein the encoder is further configured to: upsample the at least one first sample to foul a predictor for the at least one second sample.

41. The system of claim 34, wherein the encoder is further configured to: create upscaled side information from the reconstruction of the encoded at least one first sample.

42. The system of claim 41, wherein the upscaled side information comprises at least one motion vector.

43. The system of claim 34, wherein the first coding technology comprises technology identified in a Dependency Parameter Set.

44. The system of claim 34, wherein the second coding technology comprises technology identified in a Dependency Parameter Set.

45. A system for video transmission comprising:
at least one sending endpoint comprising a base layer encoder, an enhancement layer encoder, and a first capability negotiation module;
at least one receiving endpoint comprising a base layer decoder, an enhancement layer decoder, and a second capability negotiation module, the at least one receiving endpoint being coupled to the at least one sending endpoint;
wherein:
the base layer encoder and decoder are configured to code or decode, respectively, in compliance with a first video coding technology;
the enhancement layer encoder and decoder are configured to code or decode, respectively, in compliance with a second different video coding technology; and
the first capability negotiation module is configured to interact with the second capability negotiation module to negotiate a capability that utilizes all base layer encoder, base layer decoder, enhancement layer encoder, and enhancement layer decoder.

46. The system of claim 45, further comprising a CVCS coupled to the at least one receiving endpoint.

47. A non-transitory computer readable medium comprising a set of instructions to direct a processor to perform the methods of one of claims 1-44.
